(19) United States
(12) Patent Application Publication
(10) Pub. No.: US 2016/0207118 A1
(43) Pub. Date: Jul. 21, 2016

(54) DRILLING TEMPLATE FOR ASSISTING IN THE INSTALLATION OF MOUNTING BRACKETS SUCH AS FOR CURTAINS AND BLINDS FOR WINDOWS

(71) Applicant: Gregory Alan Broom, Sachse, TX (US)

(72) Inventor: Gregory Alan Broom, Sachse, TX (US)

(21) Appl. No.: 14/993,242

(22) Filed: Jan. 12, 2016

Related U.S. Application Data
(60) Provisional application No. 62/104,111, filed on Jan. 16, 2015.

(51) Int. Cl. B23B 49/02

(52) U.S. Cl. CPC B23B 49/02; B23B 2260/104

(57) ABSTRACT

A template is provided to assist in the installation of hardware around windows. The template includes openings for use in marking or drilling wall structures. The openings are located with respect to an inside corner feature that is aligned with the window opening. A lip structure is provided at the inside corner feature and configured to engage both cased and non-cased windows.

### CROSS REFERENCE TO RELATED APPLICATION

This application claims priority from U.S. Provisional Patent Application No. 62/104,111 filed Jan. 16, 2015, the disclosure of which is incorporated by reference.

### BACKGROUND OF THE INVENTION

1. Technical Field of the Invention

The present invention relates generally to a template (or jig) that is useful in installing hardware, such as mounting brackets, at symmetric locations relative to an object, such as a window. The template is especially useful in determining the location of mounting holes in walls around a window location for the purpose of installing brackets for supporting curtains, drapes and blinds.

2. Description of Related Art

With respect to the installation of hardware, such as mounting brackets, for supporting curtains, drapes and blinds, it is recognized by those skilled in the art that the quality of the resulting installation is heavily dependent on accurately placing the hardware mounting holes. Indeed, symmetry is critical. The height and offset from the top corners of the window for each mounting hole must be accurately positioned. Skilled workers manage the placement of mounting holes with relative ease. A homeowner, lacking experience in measurement and alignment, often fails at first attempt to properly locate the mounting holes. Damage to the walls around the window may result. Additionally, symmetry may be lost with incorrect placement.

A need exists in the art for a template and jig to assist in the accurate placement of mounting holes relative to a window opening.

### BRIEF DESCRIPTION OF THE DRAWINGS

A more complete understanding of the method and apparatus of the present invention may be acquired by reference to the following Detailed Description when taken in conjunction with the accompanying Drawings wherein:

FIGS. 1-2 are front and back perspective views of an embodiment of a template;

FIGS. 3-4 are front and back perspective views of an embodiment of a template; and

FIG. 5 is a cross-sectional view of either embodiment.

### DETAILED DESCRIPTION

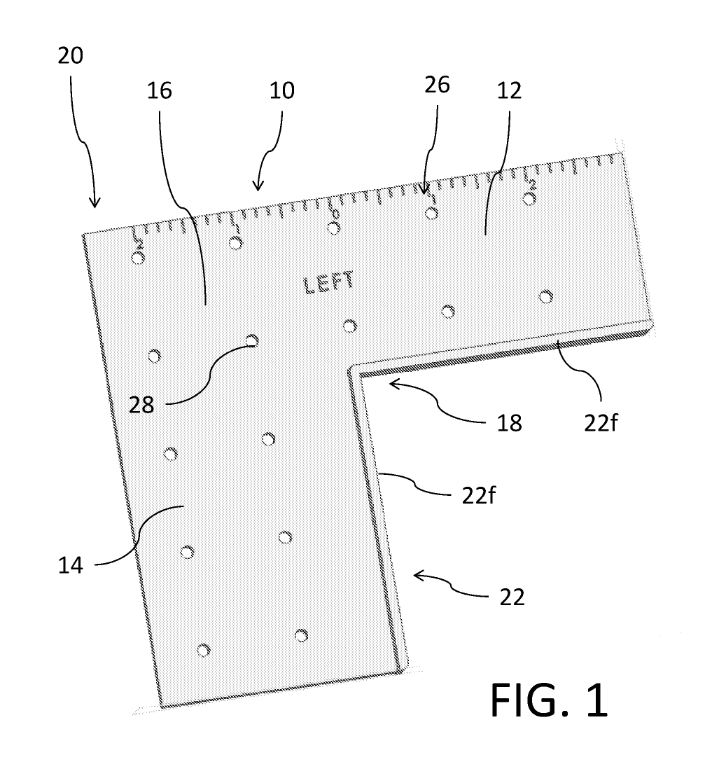

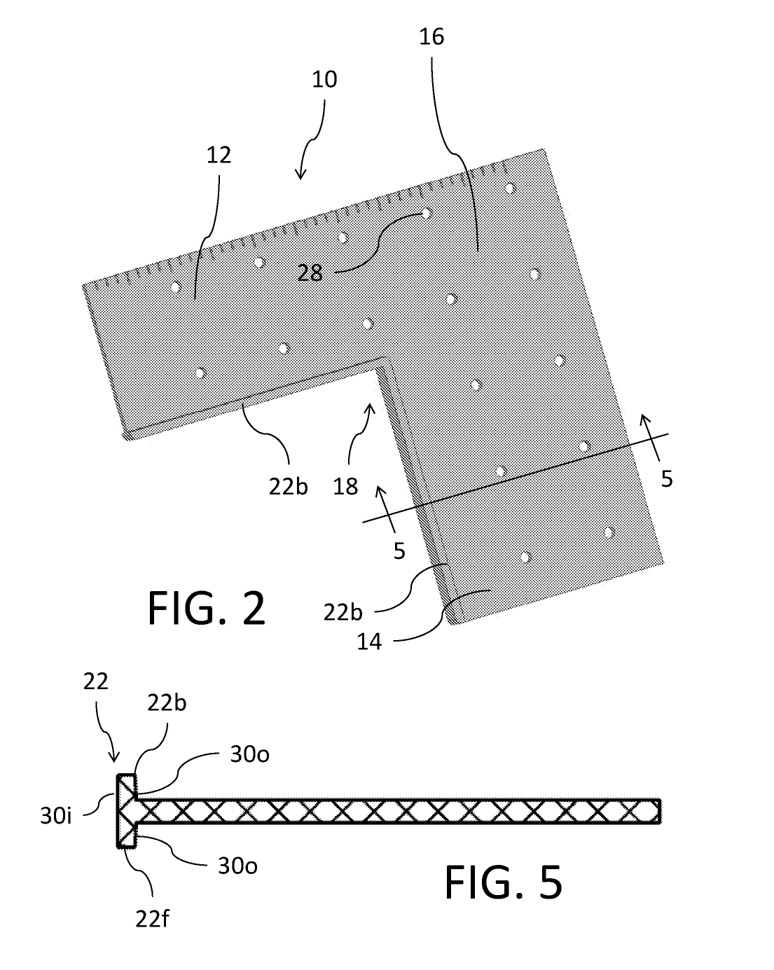

Reference is now made to FIGS. 1-2 showing front and back perspective views of a first embodiment of a template 10. The template 10 is formed of a flat sheet of material which has an L-shape including a first leg 12 and a second leg 14 (perpendicular to each other) that are joined at a central portion 16. The L-shaped structure of the template 10 defines an inside corner 18 of 90° and an outside corner 20 also of 90°. Along edges of the inside corner 18, a lip structure 22 is formed. This lip structure 22 comprises a front ridge 22f extending from and perpendicular to a front surface of the sheet material along the edges of the inside corner and a back ridge 22b extending from and perpendicular to a back surface of the sheet material along the edges of the inside corner. This is shown in more detail in cross-sectional FIG. 5. One or more of the edges of the outside corner 20 are marked with ruler indicia 26. The template further includes a plurality of openings 28. The locations of the openings are chosen to account for standard offset and spacing distances from the inside corner 18. For example, openings spaced apart by one inch with an offset from the edges of the inside corner 18 of, for example, one-half inch and one inch. This is just an example of the possible offsets and spacings. The openings may be arranged with a regular pattern or may instead be provided with a specific configuration that is unique to a given installation. Although ruler indicia are shown, this is by example only, it being understood that other indicia may instead be used (for example, indicia specific to identifying certain openings or groups of openings for a given installation). The openings 28 may, for example, have a diameter of slightly more than one-eighth inch so as to accommodate passage of a standard one-eighth inch drill bit. Although all openings are shown of the same size, it will be understood that the included openings may have different sizes, for example to account for different installations.

The lip structure 22 presents an inside corner surface 30i that is perpendicular to the top and bottom surfaces of the legs 12 and 14. When the template is used in connection with a cased window opening, the inside corner surface is positioned in engaged contact with the corresponding outside corner surface of the casing or millwork for the window and the sheet material for the legs is positioned on the wall surface. The structure 22 further presents an outside corner surface 30o for each of the front and back surfaces of the sheet material. This outside corner surface 30o is also perpendicular to the top and bottom surfaces of the legs 12 and 14. When the template is used in connection with an un-cased window opening, one of the outside corner surfaces 30o is positioned in engaged contact with the corresponding inside corner surface of the window opening and the sheet material for the legs is positioned on the wall surface.

The template may include other indicia such as words indicating orientation or use of the template. FIG. 1, for example, includes indicia “LEFT” indicating to the user that the template should preferably be used in the upper left corner of the window when the “LEFT” indicia is visible. The opposite side of the template may, for example, include the indicia “RIGHT” or alternatively be left blank to infer usage in the upper right corner of the window

After positioning the template at a corner of the window, the user may select one or more of the included openings 28. Using a marking instrument, such as carpenter's pencil, a pen or marker, a marking dot may be placed on the wall by passing the marking instrument through each of the selected openings. The template may then be removed and the holes drilled at the marked location. Alternatively, after selecting the desired openings, a drill bit attached to a power drill may be passed through each of the selected openings to make corresponding holes.

The process as just described is then repeated on the opposite window corner with the template flipped over. It is important to select the correspondingly located openings when marking and/or drilling at the opposite window corner.

By following this process, the user is ensured of making a symmetric set of holes for use in hardware installation.

The template is preferably made of a hard plastic material. In this configuration, the template may be manufactured by any suitable molding process. Alternatively, the template may be made from metal sheet material using known stamping, cutting and bending processes. In a preferred implementation, the template is made of a transparent plastic material.

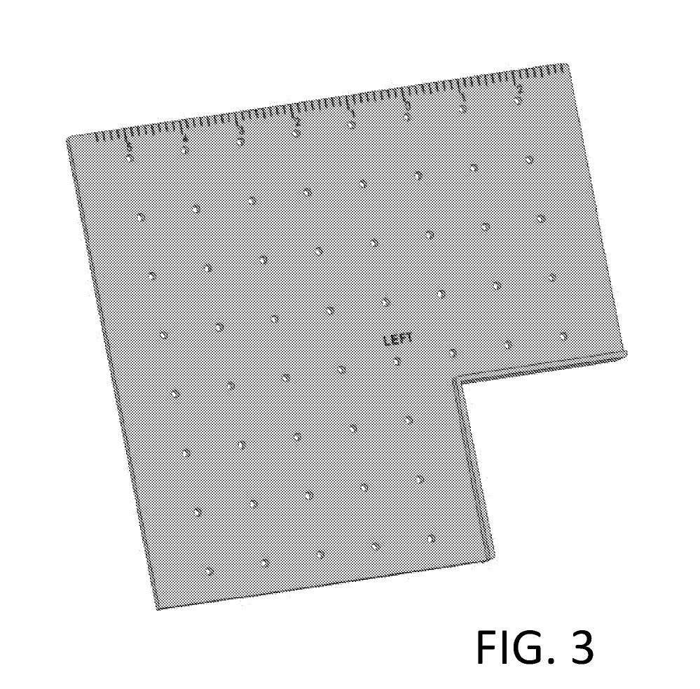

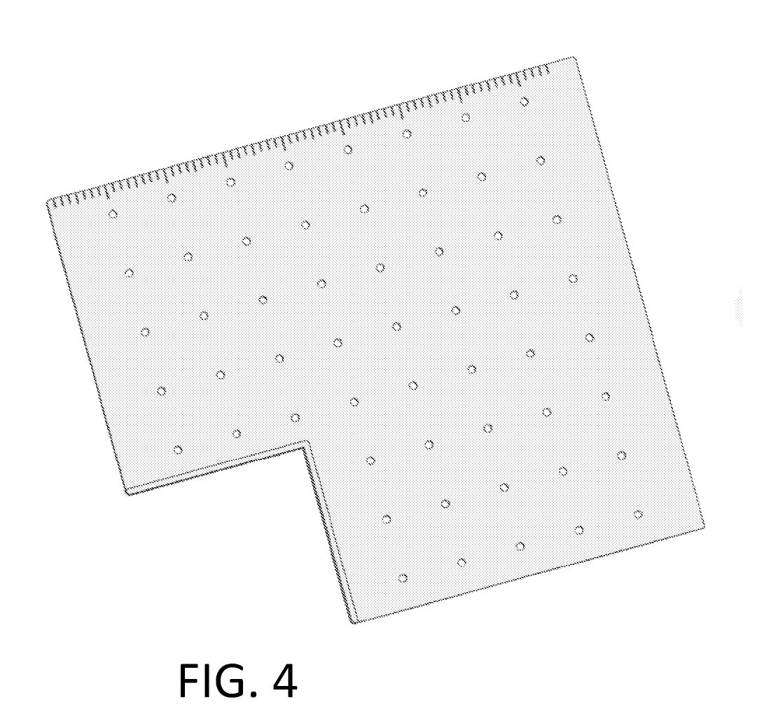

FIGS. 3 and 4 show views of another embodiment of the template. The template of FIGS. 3 and 4 differs from that shown in FIGS. 1 and 2 mainly in terms of size, with the template of FIGS. 3 and 4 being larger and including more openings. The template of FIGS. 3 and 4 further includes more detailed information relating to the ruler indicia.

In an embodiment, the openings 28 may be sized to accept mounting of other tools to the template 10. For example, the openings 28 may accept mounting of a leveling tool such as a leveling bubble or a laser for use in projecting a visible alignment line.

The template may further be useful in connection with the hanging of picture frames and mirrors.

The template may further be useful in connection with the installation of knobs and pulls on drawers and cabinets.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. An apparatus, comprising: a sheet of material having an L-shape defining an inside corner of 90° and including a first inside edge and a second inside edge perpendicular to the first inside edge, a lip structure formed at the inside corner and extending along at least a portion of each of the first and second inside edges, and a plurality of openings passing through the sheet of material.

2. The apparatus of claim 1, wherein the lip structure comprises: a front ridge extending perpendicularly from a front surface of the sheet of material along the first and second edges of the inside corner, and a back ridge extending perpendicularly from a back surface of the sheet of material along the first and second edges of the inside corner.

3. The apparatus of claim 1, wherein the plurality of openings are arranged with a repeating spacing.

4. The apparatus of claim 1, wherein the L-shape of the sheet of material further defines an outside corner including a first outside edge and a second outside edge perpendicular to the first outside edge.

5. The apparatus of claim 4, further including ruler indicia extending along at least of the first and second outside edges.

6. The apparatus of claim 1, wherein the lip structure includes an inside corner surface configured to engage an outside corner surface of a cased window.

7. The apparatus of claim 1, wherein the lip structure includes an outside corner surface configured to engage an inside corner surface of a non-cased window.
